(19) United States
(12) Patent Application Publication
(10) Pub. No.: US 2010/0208747 A1
(43) Pub. Date: Aug. 19, 2010

(54) OUTPUT DEMULTIPLEXING FOR DYNAMIC BANDWIDTH ALLOCATION IN PASSIVE OPTICAL NETWORKS

(75) Inventors: David Gordon, Montreal (CA); Bjorn Skubic, Hasselby (SE); Martin Julien, Laval (CA); Ludovic Beliveau, Montreal (CA)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/388,180

(22) Filed: Feb. 18, 2009

(51) Int. Cl. H04J 3/22; H04J 14/00

(52) U.S. Cl. 370/468; 398/58

(57) ABSTRACT

Systems and methods according to these exemplary embodiments provide for mechanisms and methods that allow for improving the efficiency of a passive optical network (PON). Upstream data transmission can occur by allowing an optical network unit (ONU) cycle to overlap more than one GPON transmission convergence (GTC) frame. Additionally, or alternatively, multiple different bandwidth maps can be transmitted per dynamic bandwidth allocation (DBA) cycle to inform ONUs of their respective, upstream bandwidth allocations.

### TECHNICAL FIELD

The present invention relates generally to telecommunications systems and in particular to methods and systems for improving upstream transmission efficiency in passive optical networks.

### BACKGROUND

Communications technologies and uses have greatly changed over the last few decades. In the fairly recent past, copper wire technologies were the primary mechanism used for transmitting voice communications over long distances. As computers were introduced the exchange of data between remote sites became desirable for many business, individual and educational purposes. The introduction of cable television provided additional options for increasing communications and data delivery from businesses to the public. As technology continued to move forward, digital subscriber line (DSL) transmission equipment was introduced which allowed for faster data transmissions over the existing copper phone wire infrastructure. Additionally, two way exchanges of information over the cable infrastructure became available to businesses and the public. These advances have promoted growth in service options available for use, which in turn increases the need to continue to improve the available bandwidth for delivering these services, particularly as the quality of video and overall amount of content available for delivery increases.

One promising technology that has been introduced is the use of optical fibers for telecommunication purposes. Optical fiber network standards, such as synchronous optical networks (SONET) and the synchronous digital hierarchy (SDH) over optical transport (OTN), have been in existence since the 1980s and allow for the possibility to use the high capacity and low attenuation of optical fibers for long haul transport of aggregated network traffic. These standards have been improved upon and today, using OC-768/STM-256 (versions of the SONET and SDH standards respectively), a line rate of 40 gigabits/second is achievable using dense wave division multiplexing (DWDM) on standard optical fibers.

In the access domain, information regarding optical networking can be found in Ethernet in the First Mile (EFM) standards supporting data transport over point-to-point (p2p) and point-to-multipoint (p2mp) optical fiber based access network structures. Additionally the International Telecommunications Union (ITU) has standards for p2mp relating to the use of optical access networking, e.g., ITU-T G.984. Networks of particular interest for this specification are passive optical networks (PONs). Three PONs are, e.g., Ethernet PONs (EPONs), Broadband PONs (BPONs) and Gigabit capable PONs (GPONs), characteristics of which are displayed below for comparison in Table 1.

TABLE 1
Major PON Technologies and Properties

| Characteristics | EPON | BPON | GPON |
|---|---|---|---|
| Standard | IEEE 802.3ah | ITU-T G.983 | ITU-T G.984 |
| Protocol | Ethernet | ATM | Ethernet |
| Rates (Mbps) | 1244 up/1244 | 622/1244 down | 1244/2488 down |
| | down | 155/622 up | 155 to 2488 up |
| Span (Km) | 10 | 20 | 20 |
| Number of Splits | 16 | 32 | 64 |

PON efficiency can be affected by numerous factors, for example, transmit power, distance, traffic volume, quality of equipment, quiet windows, etc. While there is often a tradeoff between cost and efficiency, efficiency improvements can reduce the overall cost of a system, particularly when considered over time. Another factor that can affect PON efficiency is the number of optical network units (ONUs) supported by each optical line termination (OLT) in the PON. The more ONUs per OLT in a PON, the more splitting of the optical signal (which increases the link budget) and the more control signaling that is typically required, which leads to more inefficiencies in the desired data transfers. As this technology matures, PONs could scale from 32 ONUs per OLT to possibly, 64, 128 or more per OLT, particularly if these ONUs are located relatively close to their OLT e.g., within 20 kilometers. As such, it would be desirable to decrease inefficiencies in PONs.

### SUMMARY

According to one exemplary embodiment a method for communications in a passive optical network having an optical line terminal (OLT) unit connected to a plurality of optical network units (ONUs), the method includes: optically transmitting at least one data packet from each of the plurality of ONUs toward the OLT during each of a plurality of ONU cycles, wherein at least one of said ONU cycles has a time duration of a plurality of Media Access Control (MAC) frame periods.

According to another exemplary embodiment a method for communications in a passive optical network having an optical line terminal (OLT) unit connected to a plurality of optical network units (ONUs), the method includes: optically transmitting, by the OLT, a first bandwidth allocation message during a dynamic bandwidth allocation (DBA) cycle; receiving, at the OLT, a first number of data packets from one of the plurality of ONUs associated with a first ONU cycle within the DBA cycle, which first number is based upon the first bandwidth allocation message; optically transmitting, by the OLT, a second bandwidth allocation message during the DBA cycle; and receiving, at the OLT, a second number of data packets from the one of the ONUs associated with a second ONU cycle within the DBA cycle, which second number is based upon the second bandwidth allocation message, the second number of data packets being different from the first number of data packets.

According to yet another exemplary embodiment, a communications node in a passive optical network includes a processor for executing instructions, and a. communications interface which transmits at least one data packet toward an optical line termination (OLT) during each of a plurality of optical network unit (ONU) cycles, wherein at least one of said ONU cycles has a time duration of a plurality of Media Access Control (MAC) frame periods.

According to still another exemplary embodiment, a communications node in a passive optical network includes a memory for storing program instructions associated with a dynamic bandwidth allocation (DBA) algorithm, a processor for executing the program instructions associated with the DBA algorithm which results in generation of a plurality of different bandwidth maps which describe a DBA cycle associated with upstream transmissions, and a communications interface for transmitting the plurality of different bandwidth maps in downstream frames during the DBA cycle.

### BRIEF DESCRIPTION OF THE DRAWINGS

The accompanying drawings illustrate exemplary embodiments, wherein:

FIG. 1 depicts a Gigabit capable Passive Optical Network (GPON);

FIG. 2 illustrates upstream and downstream data flow in a GPON;

FIGS. 3(a)-(c) show various parts of a downstream GPON Transmission Convergence (GTC) frame;

FIG. 4(a) depicts two optical network units (ONUs) with associated transmission containers (T-CONTs) in a GPON;

FIG. 4(b) illustrates a relationship between various transmission cycles used to transmit upstream data;

FIG. 5 shows the conventional usage of a single bandwidth map during an entire dynamic bandwidth allocation (DBA) cycle in a GPON;

FIG. 6 illustrates the usage of multiple bandwidth maps during a DBA cycle according to exemplary embodiments;

FIG. 7 shows bandwidth allocations for upstream transmissions during a DBA cycle using multiple bandwidth maps according to exemplary embodiments;

FIG. 8 shows a communications node according to exemplary embodiments;

FIG. 9 shows a method flowchart for communications in a PON according to exemplary embodiments; and

FIG. 10 depicts another method flowchart for communications in a PON according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

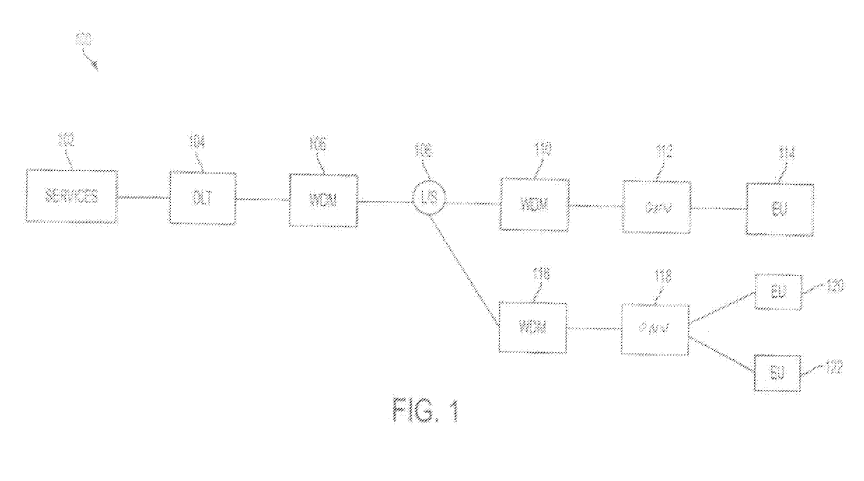

According to exemplary embodiments it is desirable to provide mechanisms and methods that improve the efficiency of passive optical networks (PON). In order to provide some context for this discussion, an exemplary Gigabit-capable PON (GPON) is shown in FIG. 1. While a GPON is used as the basis of discussion herein, other types of PONs, e.g., Ethernet PONs (EPONs) and Broadband PONs (BPONs), could benefit from the exemplary embodiments described below with minor variations as would be understood by one skilled in the art.

According to exemplary embodiments, GPON 100 in FIG. 1 shows elements of an optical distribution network (ODN) that interact with various endpoints of optical network units (ONUs). As shown in FIG. 1, one or more service providers or types 102 can be in communication with an optical line termination (OLT) 104, which is typically located in a central office (CO) (not shown). The OLT 104 provides the network side interface and is typically in communication with at least one ONU 112, 118 (or an optical network termination (ONT) which performs similar functions as an ONU). These service providers 102 can provide a variety of services such as video-on-demand or high definition television (HDTV), Voice over IP (VoIP) and high speed internet access (HSIA). The OLT 104 transmits information to multiplexer 106 which multiplexes the data and transmits the data optically to a passive combiner/splitter 108. The passive combiner/splitter 108 then splits the signal and transmits it to the upstream multiplexers 110 and 116. The multiplexers 110 and 116 demultiplex the signal and forward it on to their respective ONUs 112 and 118. The multiplexers (108, 110 and 116) are typically integrated into both the OLT and the ONUs and are used for aggregating and extracting the upstream and downstream wavelengths. The ONUs 112 and 118 then forward the information onto their respective end users (EU) 114, 120 and 122, e.g., devices such as a computer, a television, etc.

It will be understood by those skilled in the art that this purely illustrative GPON 100 can be implemented in various ways, e.g., with modifications where different functions are combined or performed in a different manner. For example the multiplexers (108, 110 and 116) typically are duplexers, but if an additional signal is being transmitted, e.g., a cable-television signal in a GPON 100, they can act as triplexers. Additionally in the upstream direction, the optical signal would typically have a different wavelength from the downstream signal and use the same multiplexers 106, 110 and 116, which have bidirectional capabilities.

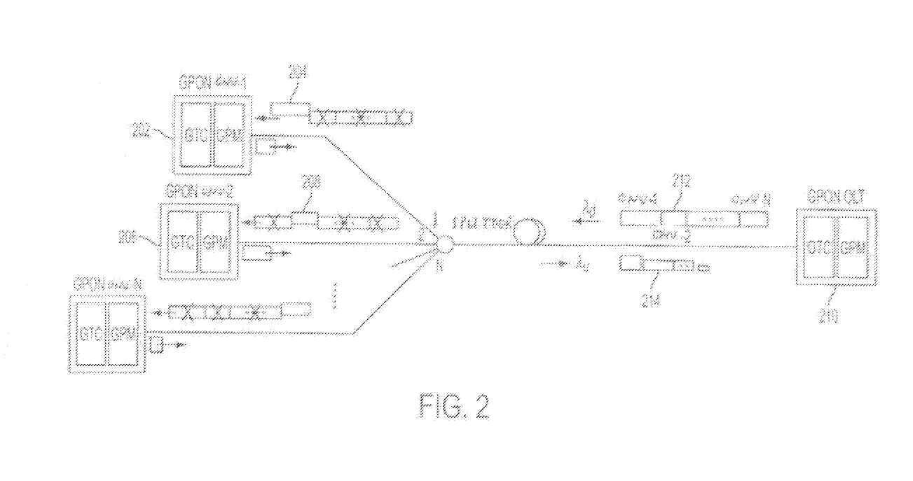

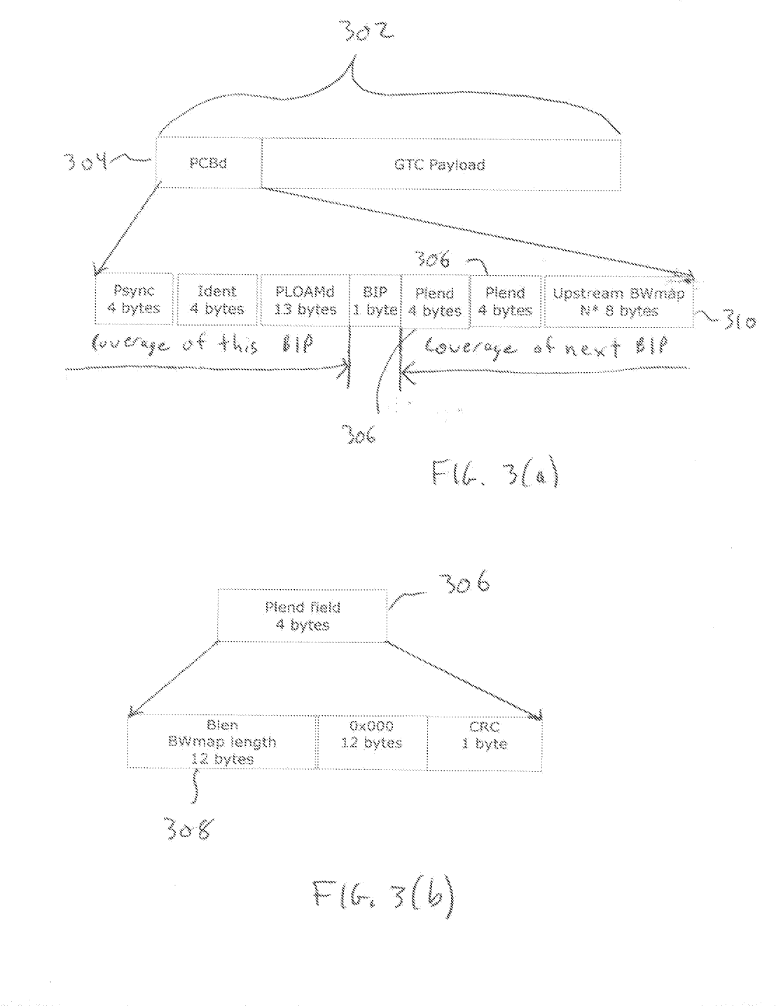

FIG. 2 shows upstream and downstream data flow for GPON 100. In the upstream direction, a bandwidth map is used in the GPON 100 to describe when ONUs 202 and 206 are allowed to transmit upstream data in granted or allocated time-slots on their optical wavelength(s). This means that ONUs 202, 206 transmit in a burst mode at their allotted time slots, as compared to a 125 μs long frame 212 in the downstream direction from the OLT 210. Since the ONUs 202, 206 are located at different distances from the OLT 210, the ONUs 202, 206 are informed by the OLT 210 when, and with what power, to transmit their respective bursts so that the ONUs signals are arriving in an aligned time structure at the OLT 210.

In the downstream direction, the OLT 210 transmits a 125 μs long frame 212 which is composed of a GPON transmission convergence (GTC) header and a GTC payload. The GTC payload typically contains a sequence of GPON encapsulation method (GEM) headers and GEM payloads, with the GEM header containing information identifying the destination ONU, e.g., the ONU-ID, and the GEM payload containing the desired data. In FIG. 2 each ONU 202, 206 is shown as receiving a single GEM header/payload segment within the frame 212 in sequential order, however it is also possible for an ONU 202, 206 to receive multiple GEM header/payload segments within a single downstream frame 212 in whatever order the OLT 210 decides to use since each ONU can filter the downstream data based, e.g., on its assigned ONU-ID. Each of the ONUs 202, 206 and the OLT 210 may include various protocol stack processing entities including, for example, a GTC processing entity and a GPON physical medium (GPM) processing entity. More information regarding GTC and GPM can be found in ITU-T G.984.3 which is incorporated herein by reference.

As described above, FIG. 2 shows a system where each ONU 202, 206 is assigned or allocated a time slot for its upstream transmission. Dynamic Bandwidth Allocation (DBA) algorithms can be used to manage the upstream bandwidth in a PON. DBA is a technique by which traffic bandwidth in a shared telecommunications medium, e.g., GPON 100, can be allocated on demand (or relatively on demand) and fairly (or in any desired manner) between different users of that bandwidth. DBA algorithms are similar to statistical multiplexing techniques and allow for the shared transmission medium to adapt to changing traffic demands of the nodes sharing the transmission medium. Additionally, DBA algorithms can take into account various attributes of a shared network in determining allocations, e.g.,: by considering (1) that all users are typically not connected to the network at the same time, (2) that, when connected, not all users are transmitting data at all times, (3) that most traffic is “bursty”, i.e., there are transmission gaps between packets of information that can be filled with other user traffic, and (4) provisioned Service Level Agreement(s) on the type of traffic (best effort, guaranteed, etc.) and its specific parameters (delay, committed information rate, committed burst size and the like).

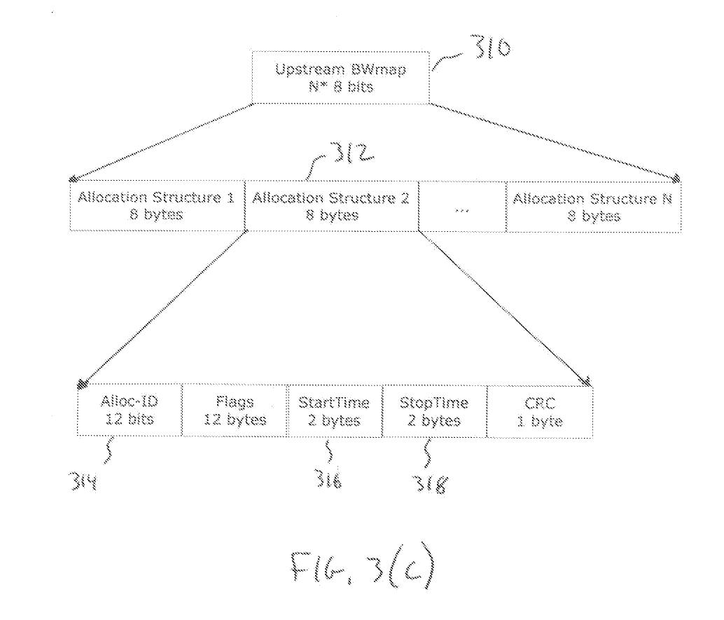

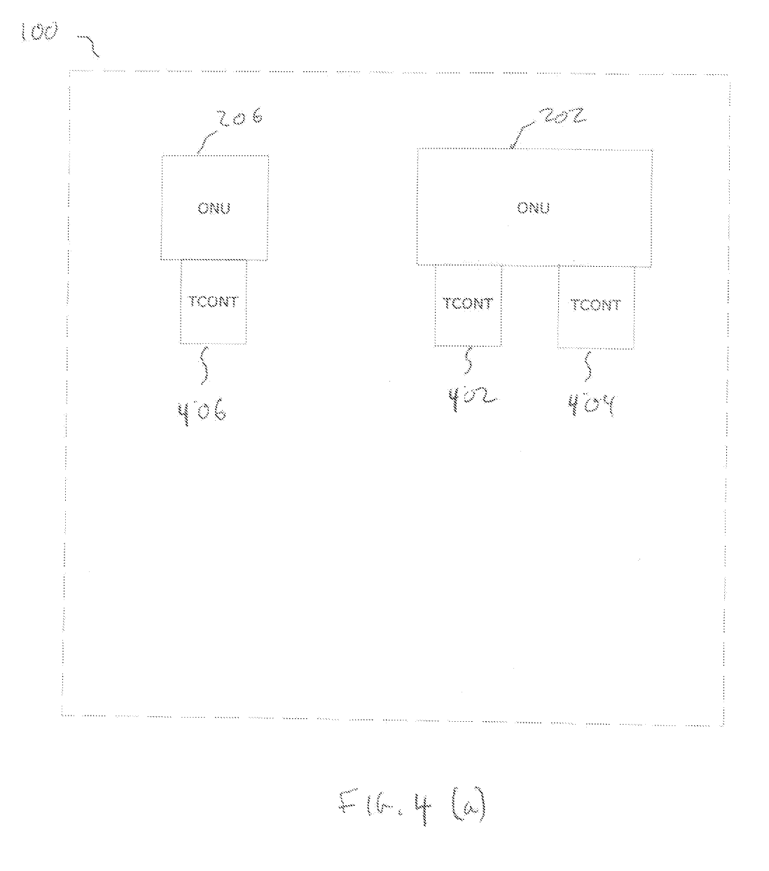

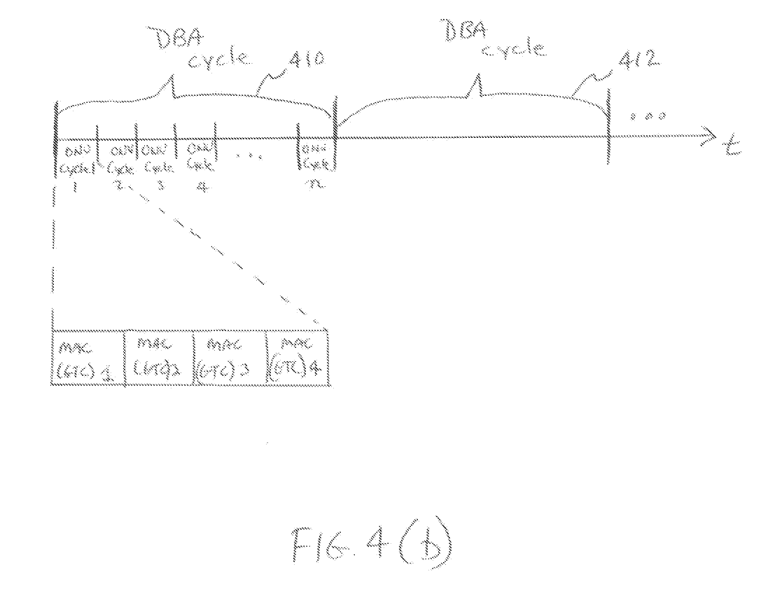

The DBA algorithm, which can be stored in the format of executable program instructions, is executed periodically on the OLT 210 by polling the active ONUs 202, 206 for traffic utilization data and calculating an upstream bandwidth map, which is then transmitted to all of the ONUs. The periodicity with which the DBA algorithm is executed to generate new upstream bandwidth maps is referred to herein as a “DBA cycle” and is described in more detail below with respect to FIG. 4(b). The upstream bandwidth map is transmitted to the ONUs 202, 206 in a downstream GTC frame 302, which is shown in FIG. 3(a), in the physical control block downstream (PCBd) 304. Within the PCBd 304 is a Payload Length downstream (Plend) field 306 which indicates, as shown in FIG. 3(b), the length of the bandwidth map in the bandwidth (BW) map length field 308. Also contained in the PCBd 304 is the Upstream BWmap field 310 which is shown in FIG. 3(c). Upstream BWmap field 310 includes an Allocation Structure field 312 for each Alloc-ID 314 associated with each ONU (and/or for each transmission container (T-CONT) associated with each ONU) active in the GPON 100. The Allocation Structure field 312 includes an Alloc-ID 314 for identifying the ONU/T-CONT, as well as a start time 316 and stop time 318 for transmitting in their respective allocated upstream bandwidths.

As described above, a GPON 100 typically includes various ONUs 202, 206 each of which may, in turn, include one or more T-CONTs which serve as logical queues for transmitting data. An illustration of this is shown in FIG. 4(a), where ONU 202 has two T-CONTs 402, 404 and ONU 206 has one T-CONT 406. These T-CONTs are addressable, e.g., each T-CONT 402, 404, 406 has its own unique Alloc-ID 314, and can be given their own bandwidth allocation for upstream transmissions by the OLT 212 by a DBA algorithm.

Illustrating the relationship between some of the transmission cycles used below and their corresponding structures will hopefully render more easily understood the further discussion of the exemplary embodiments. As shown in FIG. 4(b), at a high level, upstream transmissions are performed as a function of time in DBA cycles 410, 412, etc. As mentioned above, a DBA cycle 410, 412 defines the periodicity of recalculating the distribution of upstream bandwidth, i.e., the DBA cycles 410, 412 correspond to the periodicity of executing the DBA algorithm in an OLT processor or the like. Each DBA cycle 410, 412 can include a plurality of ONU cycles. For example, as shown in FIG. 4(b), DBA cycle 410 can include n ONU cycles, wherein n could be 1, 2, 4, 8, 16, etc. Within each ONU cycle, all of the ONUs 202, 206 (and their respective queue(s) or T-CONT(s)) cyclically have been scheduled for upstream transmission of data. An ONU cycle can, for example, have a time duration or period of one MAC frame (e.g., GTC frame). However, according to exemplary embodiments, an ONU cycle can include more than one MAC frame (e.g., GTC frame), e.g., 2, 3, 4 (as shown in FIG. 4(b)), or more MAC frames. Typically, a DBA cycle is divided into a plurality of ONU cycles, each ONU cycle being equal in size, although this is not required. During one of the ONU cycles, sometimes referred to as the polling cycle, the DBA algorithm obtains updated buffer contents of the ONU queues to be used to generate bandwidth map messages for the next DBA cycle.

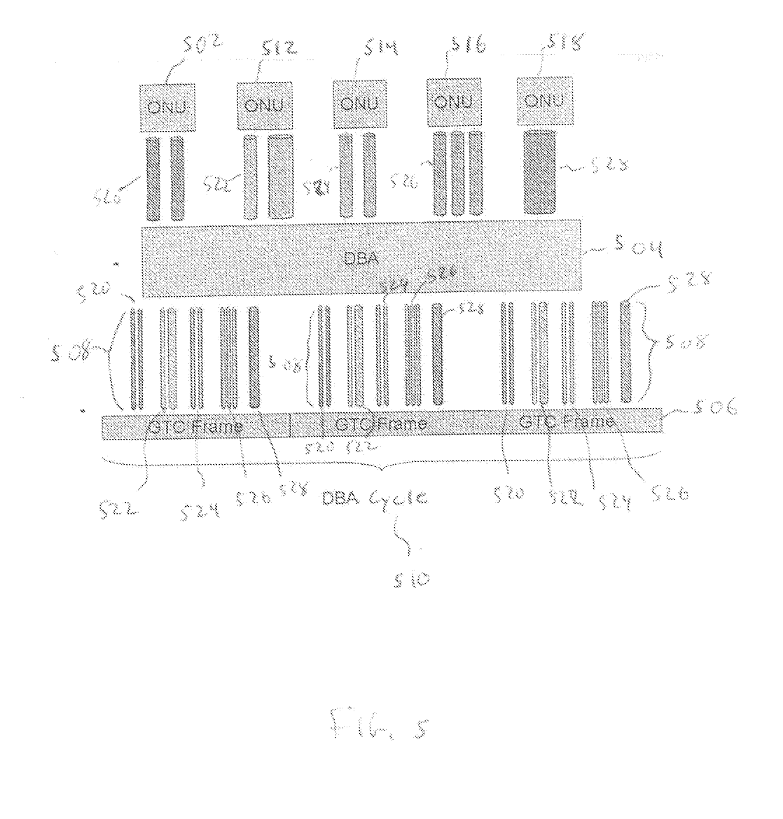

FIG. 5 illustrates a mapping between information obtained from polling requests, e.g., the number of data stream(s) (associated with T-CONT(s)) which each ONU wishes to transmit during a given DBA cycle and the requested bandwidth for each data stream, and the actual bandwidth allocations generated by a conventional DBA algorithm in response to those polling inputs. For example, between each ONU 502, 512, 514, 516, and 518 and the conventional DBA algorithm 504 there are illustrated one or more cylinders numbered by groups 520, 522, 524, 526 and 528. The number of cylinders in each group represents the number of data streams that each ONU intends to transmit during the upcoming DBA cycle, while the relative thickness of each cylinder represents the relative bandwidth associated with each data stream.

The conventional DBA algorithm 504 uses these inputs to allocate a certain amount of bandwidth to each transmit queue or data stream of each ONU in each GTC frame. Thus, upstream data to be transmitted by the ONUs is parceled out to each MAC frame, e.g., each GTC frame 506, according to the bandwidth map generated by the conventional DBA algorithm 504 in a repeating format as shown by the data chunks 508 (which are the same for each GTC frame in a conventional DBA cycle) over the DBA cycle 510. Again, cylinders are used in the figure to represent the number and size (by thickness) of the bandwidth allocations. Each data chunk 508 includes data from each ONU 502, 512, 514, 516, 518, i.e., each ONU 502, 512, 514, 516, 518 transmits during each GTC frame 506 at their respective allocation window which repeats during DBA cycle 510. For example, the same amount of data 520 from ONU 502, data 522 from ONU 512, data 524 from ONU 514, data 526 from ONU 516 and data 528 from ONU 518 are transmitted in accordance with the same pattern/bandwidth allocation in each GTC frame 508. However using a conventional DBA algorithm, e.g., wherein each ONU transmits in each GTC frame using the same bandwidth, it is anticipated that, as the number of ONUs in a PON grows from 32 to 128 or more, communications inefficiencies will increase.

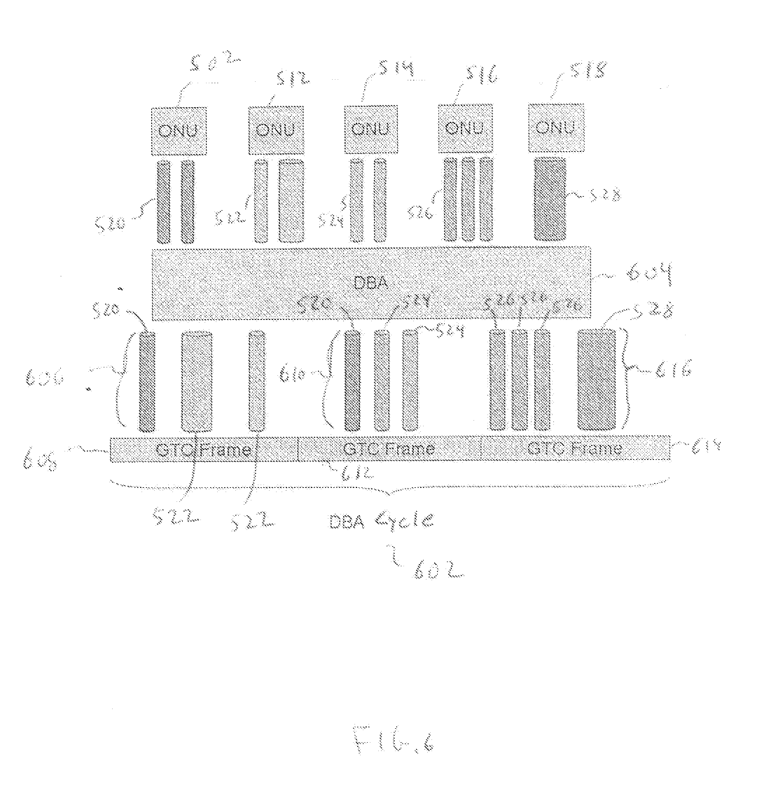

According to exemplary embodiments, on the other hand, a DBA algorithm can generate multiple, different bandwidth maps for use by the ONUs over a single DBA cycle. A conceptual diagram according to exemplary embodiments is shown in FIG. 6, which illustrates a DBA cycle 602 which uses varying bandwidth maps to control the upstream transmissions of the ONUs from GTC frame to GTC frame. To make more relevant the comparison with FIG. 5, the same polling inputs associated with the number of data streams and their corresponding bandwidths to be transmitted by the ONUs in a next DBA cycle are used again in the example of FIG. 6, i.e., the cylinder sets 520, 522, 524, 526 and 528 representing data streams (queues) have the same number and thickness in FIG. 6 as they did in FIG. 5 between the ONUs and the DBA 604. However it can be seen that the resulting bandwidth allocations are quite different.

More specifically, according to this exemplary embodiment the upstream data is parceled out in each GTC frame according to the plurality of different bandwidth maps created and transmitted by the DBA algorithm 604. In this purely illustrative example, a different map is being used for each GTC frame 608, 612 and 614 as shown by the different data transmission patterns of representative cylinder sets 606, 610 and 616, respectively. However, it will be appreciated that the present invention is not limited to using a different bandwidth map for each MAC or GTC frame and that, more generally, exemplary embodiments contemplate using two or more different bandwidth maps per DBA cycle. Returning to FIG. 6, and more specifically, the illustrative example shows that data 520 from one of the queues of ONU 502 and data 522 from all of the queues of ONU 512 are transmitted in GTC frame 608, data 520 from the other queue in ONU 502 and data 524 from all of the queues in ONU 514 are transmitted in GTC frame 612, while all of the data 526 from ONU 516 and all of the data 528 from ONU 518 are transmitted in GTC frame 614. As shown in this example, none of the ONUs 502, 512, 514, 516, 518 has a data transmission in each GTC frame 608, 612, 614 of the DBA cycle, although, once again, the present invention is not so limited.

For example, as will be appreciated by those skilled in the art, different bandwidth maps and different numbers of bandwidth maps (than those shown in FIG. 6) can be used over the DBA cycle 602. For example, assuming the use of a standard 2 ms time interval, i.e., the length of 16 GTC frames, the DBA algorithm could be executed once, with the DBA algorithm generating two or more bandwidth maps for upstream transmissions during the DBA cycle 602.

The characteristic of spreading out ONU transmissions over multiple GTC frames can reduce overhead transmissions. For example, a DBA algorithm can create a desired bandwidth mapping for the ONUs and T-CONTs by optimizing desired performance parameters such as DBA response time and jitter for different queues and traffic classes and by not restricting a single ONU cycle to one GTC frame. This allows for the accommodation of various sizes and types of traffic to be transmitted as desired in a more efficient manner. For example, traffic which is sensitive to longer response times may be scheduled earlier in the DBA cycle 602, i.e., in one of the first ONU cycles. For another example, voice traffic from a single ONU which tends to be jitter sensitive, i.e., variation of delay sensitive, can be put in relatively smaller chunks more frequently throughout a DBA cycle 602. Moreover, traffic with fixed bandwidth, as well as best-effort bandwidth, may be scheduled towards the end of the DBA cycle 602.

Using multiple bandwidth map messages per DBA cycle according to these exemplary embodiments, traffic can be scheduled on a per queue basis as compared to being scheduled purely based on traffic requirements associated with the various traffic classes, since each queue is often associated with several traffic classes. Also, a DBA scheme can be created according to exemplary embodiments where traffic requirements are also directly associated with queues which can simplify the upstream scheduling algorithm.

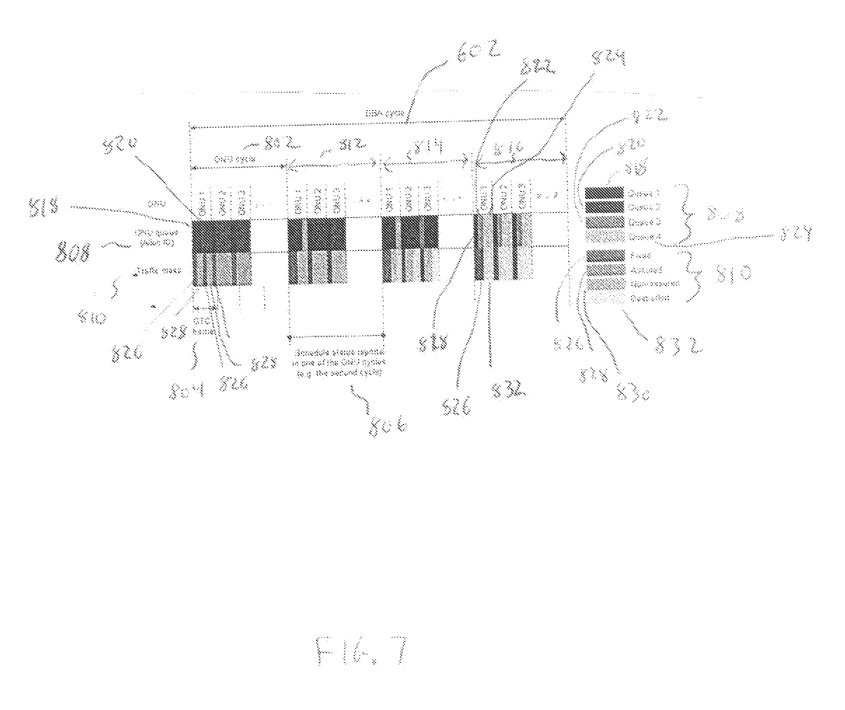

To better understand these features of the exemplary embodiments, a more detailed example of upstream scheduling and multiple bandwidth maps during a DBA cycle will now be described with respect to FIG. 7. In this purely illustrative example, DBA cycle 602 has four ONU cycles 802, 812, 814 and 816, each of which has a length of four GTC frames 804 and includes the transmissions from a plurality of ONUs, e.g., ONU 1, ONU 2 and ONU 3, etc. In the first ONU cycle 802, ONUL has been allocated bandwidth for two different queues 818, 820, e.g., two different T-CONTs, with queue1 818 having data of a fixed traffic class 826 to transmit and data of an assured traffic class 828 to transmit, while queue2 820 also has data of a fixed traffic class 826 to transmit and data of an assured traffic class 828 to transmit. By way of contrast, ONU 1 in the fourth ONU cycle 816 has three different queues 818, 822 and 824 which have been allocated bandwidth for transmission. More specifically, queue1 818 has data of a fixed traffic class 826 to transmit, queue3 822 has data of a fixed traffic class 826 to transmit and queue4 824 has data of a best effort traffic class 832 to transmit. While not described in detail, the other ONUs within the ONU cycles show other combination of queues and traffic classes which have been allocated different bandwidths in different GTC frames based on the different bandwidth maps which they have received.

Numerous variations on the foregoing exemplary embodiments are contemplated. For example, while traffic classes 810 are shown in FIG. 7 to highlight the different bandwidth maps being used in this example, the DBA algorithm according to this exemplary embodiment can generate outputs for queues 808 as a function of Alloc-IDs, traffic classes or some combination thereof. Status reports, e.g., part of a polling cycle, are shown as being part of the second ONU cycle 806, however the polling cycle could have been scheduled for any ONU cycle as desired. Moreover, as mentioned earlier, the DBA algorithm according to this exemplary embodiment can generate multiple bandwidth maps for a DBA cycle 602 which reduces overhead yet complies with other desired system parameters, e.g., jitter requirements for jitter sensitive traffic classes. For example, the DBA algorithm can begin with a desired length of the DBA cycle 602, e.g., the desired length in ONU cycles and/or GTC frames, and the desired lowest possible frequency of ONU bursts to comply with the desired system parameters. Additional information can be obtained from information appended to the T-CONT descriptor of a specific Alloc-ID regarding, jitter, delay requirements and the like, for use in the DBA algorithm for bandwidth mapping. Also, based on available information, the DBA algorithm may optimize the scheduling with respect to the different traffic classes 810.

The DBA algorithm then determines how the different queues 808 of the various ONUs are to be scheduled during the assigned transmission time points for each ONU. If there are several ONU cycles in a DBA cycle 602, the DBA algorithm may schedule the transmission of different queues in different ONU cycles. The transmission of queues with jitter sensitive traffic classes may occur during each ONU cycle, whereas the transmission of response sensitive traffic can be scheduled in the earlier ONU cycles and transmission of best-effort type traffic in the later ONU cycles. Thus, according to exemplary embodiments, using the DBA algorithm, bandwidth maps can be generated and implemented over the course of a DBA cycle 602 which minimize overhead by using the largest ONU cycle which respects the system requirements, e.g., jitter requirements, the desire for the DBA cycle to be a multiple of the ONU cycle and whereby the ONU cycle roughly determines the transmission slots of each ONU.

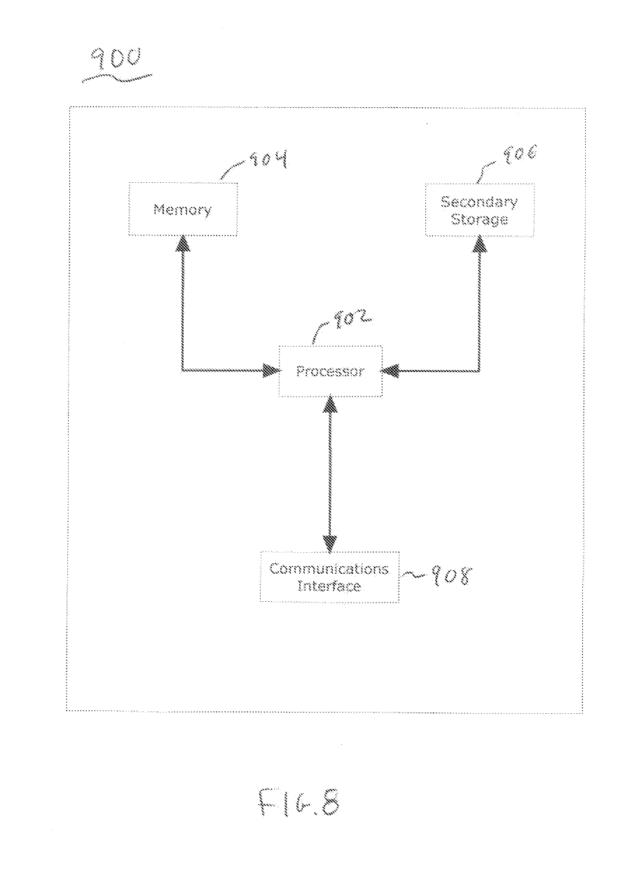

The exemplary embodiments described above provide methods and systems for improving the upstream transmission efficiency in PONs, e.g., a GPON 100, which include various communications nodes, an example of which is shown in FIG. 8. Therein, communications node 900 can contain a processor 902 (or multiple processor cores), memory 904, one or more secondary storage devices 906 and a communications interface 908. Processor 902 is capable of processing instructions in support of performing the duties of an OLT 210, more specifically processor 902 can use/generate a DBA algorithm for creating upstream scheduling bandwidth maps for ONUs. For example, processor 902 can create bandwidth maps which allow an ONU cycle to exceed the size of a GTC frame and can create and transmit multiple, different bandwidth maps per DBA cycle. As another example, the communications interface 908 can include elements of an optical transceiver to permit the communications node to transmit and receive optical signals, e.g., an optical modulator, an optical demodulator, and one or more lasers connected to optical fiber. As such, communications node 900 is capable of performing the tasks of an OLT 210 as described in the exemplary embodiments herein to augment the capabilities of a PON. Additionally, communications node 900 is capable of performing the duties of an ONU, i.e., communications node 900 can take a received bandwidth maps and correctly implement them to vary its upstream transmissions toward an OLT from GTC frame to GTC frame in a DBA cycle.

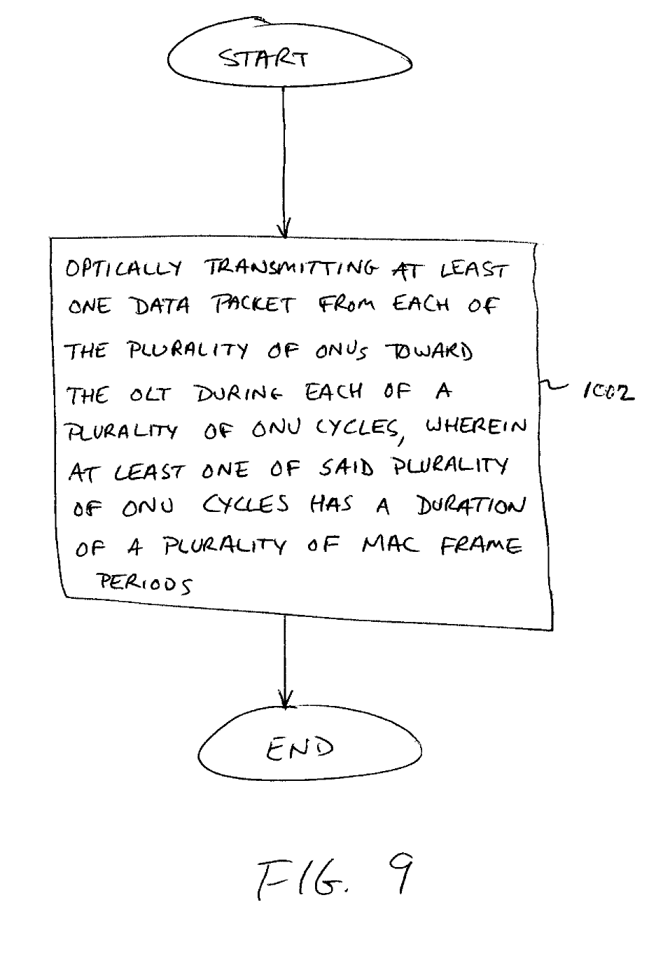

Utilizing the above-described exemplary systems according to exemplary embodiments, a method for communications in a PON is shown in the flowchart of FIG. 9. Initially a method for communications in a passive optical network having an optical line terminal (OLT) unit connected to a plurality of optical network units (ONUs), the method includes: optically transmitting at least one data packet from each of the plurality of ONUs toward the OLT during each ONU cycle, wherein at least one ONU cycle has a time duration of a plurality of MAC frame periods in step 1002.

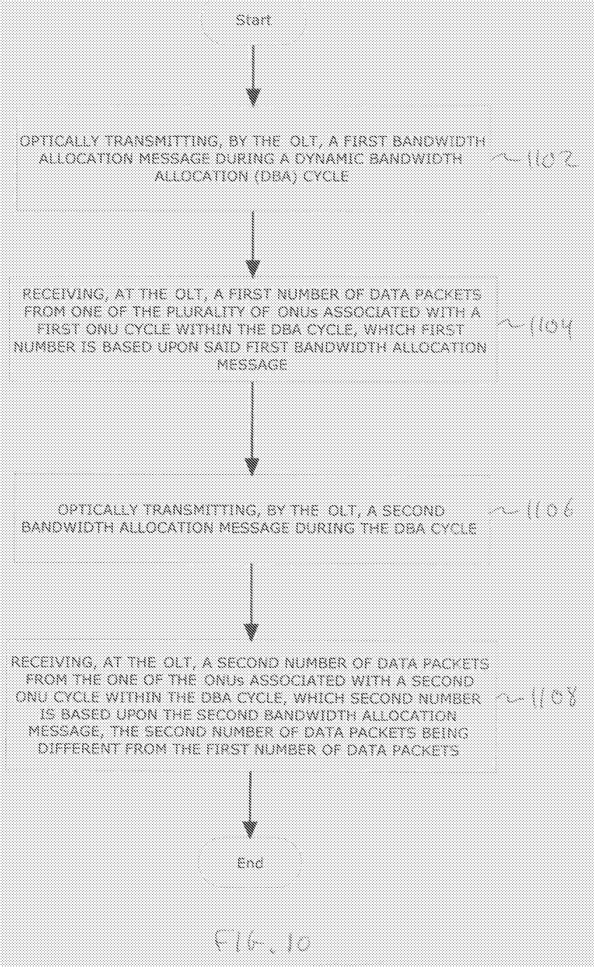

Utilizing the above-described exemplary systems according to exemplary embodiments, another method for communications in a PON is shown in the flowchart of FIG. 10. Initially a method for communications in a passive optical network having an optical line terminal (OLT) unit connected to a plurality of optical network units (ONUs), the method includes: optically transmitting, by the OLT, a first bandwidth allocation message during a dynamic bandwidth allocation (DBA) cycle in step 1102; receiving, at the OLT, a first number of data packets from one of the plurality of ONUs associated with a first ONU cycle within the DBA cycle, which first number is based upon the first bandwidth allocation message in step 1104; optically transmitting, by the OLT, a second bandwidth allocation message during the DBA cycle in step 1106; and receiving, at the OLT, a second number of data packets from the one of the ONUs associated with a second ONU cycle within the DBA cycle, which second number is based upon the second bandwidth allocation message, the second number of data packets being different from the first number of data packets in step 1108.

The above-described exemplary embodiments are intended to be illustrative in all respects, rather than restrictive, of the present invention. All such variations and modifications are considered to be within the scope and spirit of the present invention as defined by the following claims. For example, the DBA algorithm could generate a single bandwidth map or at least three different bandwidth maps for use over a single DBA cycle. Also overhead for static bandwidth allocation (SBA) can be reduced by scheduling all of the ONUs over multiple GTC frames by using exemplary embodiments as described above. In the case of SBA, exemplary embodiments can generate a sequence of US BWmaps, that would not have to be recalculated every DBA cycle, since it is static. Moreover, for exemplary embodiments employing DBA, there exist two types of DBA: those with status reporting, and those without status reporting. Status reporting means that the ONUs report their queue buffer occupancy periodically, while in the non-reporting case, the DBA algorithm estimates the traffic needs for each ONU's T-CONT-based queue. Additionally, improvements similar to those as described in the exemplary embodiments herein could be used in other types of PONs. No element, act, or instruction used in the description of the present application should be construed as critical or essential to the invention unless explicitly described as such. Also, as used herein, the article “a” is intended to include one or more items.

What is claimed is:

1. A method for communications in a passive optical network having an optical line terminal (OLT) unit connected to a plurality of optical network units (ONUs), the method comprising:
optically transmitting at least one data packet from each of said plurality of ONUs toward said OLT during each of a plurality of ONU cycles,
wherein at least one of said ONU cycles has a time duration of a plurality of Media Access Control (MAC) frame periods.

2. The method of claim 1, wherein each of said MAC frame periods is a Gigabit Passive Optical Network (GPON) transmission convergence (GTC) frame period of 125 microseconds.

3. The method of claim 1, further comprising:
receiving, by one of said plurality of ONUs, a first bandwidth allocation message from said OLT during a dynamic bandwidth allocation (DBA) cycle;
optically transmitting, by said one of said plurality of ONUs, a first number of said at least one data packets during a first ONU cycle within said DBA cycle, which first number is based upon said first bandwidth allocation message;
receiving, by said one of said plurality of ONUs, a second bandwidth allocation message from said OLT during said DBA cycle; and
optically transmitting, by said one of said plurality of ONUs, a second number of said at least one data packets during a second ONU cycle, which second number is based upon said second bandwidth allocation message,
wherein said first number is different from said second number.

4. The method of claim 3, further comprising:
generating, by a DBA algorithm, different bandwidth allocations for each of said first bandwidth allocation message and said second bandwidth allocation message.

5. The method of claim 4, further comprising:
receiving polling information from each of said plurality of ONUs for use by said DBA algorithm in generating said different bandwidth allocations.

6. The method of claim 5, wherein said DBA algorithm uses constraints of overhead reduction and data packet jitter requirements when generating said different bandwidth allocations.

7. The method of claim 6, wherein said DBA algorithm generates at least three different bandwidth maps for use over a single DBA cycle.

8. The method of claim 1, wherein a number of MAC frames used in a single DBA cycle is a positive integer multiplier of said ONU cycles.

9. A method for communications in a passive optical network having an optical line terminal (OLT) unit connected to a plurality of optical network units (ONUs), the method comprising:
optically transmitting, by said OLT, a first bandwidth allocation message during a dynamic bandwidth allocation (DBA) cycle;
receiving, at said OLT, a first number of data packets from one of said plurality of ONUs associated with a first ONU cycle within said DBA cycle, which first number is based upon said first bandwidth allocation message;
optically transmitting, by said OLT, a second bandwidth allocation message during said DBA cycle; and
receiving, at said OLT, a second number of data packets from said one of said ONUs associated with a second ONU cycle within said DBA cycle, which second number is based upon said second bandwidth allocation message, said second number of data packets being different from said first number of data packets.

10. The method of claim 9, further comprising:
optically transmitting, by said OLT, a third bandwidth allocation message during another DBA cycle, said another DBA cycle having a time duration of a single Medium Access Control (MAC) frame period.

11. The method of claim 9, wherein said first and second bandwidth allocation messages are optically transmitted to a plurality of ONUs and inform each of said plurality of ONUs regarding their respective upstream bandwidth allocation.

12. The method of claim 9, wherein at least some of said ONU cycles have a time duration of a plurality of Medium Access Control (MAC) frame periods.

13. The method of claim 12, wherein each of said MAC frame periods is a Gigabit Passive Optical Network (GPON) transmission convergence (GTC) frame period of 125 microseconds.

14. The method of claim 9, further comprising:
generating, by a DBA algorithm, different bandwidth allocations for each of said first bandwidth allocation message and said second bandwidth allocation message.

15. The method of claim 14, further comprising:
receiving polling information from each of said plurality of ONUs for use by said DBA algorithm in generating said different bandwidth allocations.

16. The method of claim 15, wherein said DBA algorithm uses constraints of overhead reduction and data packet jitter requirements when generating said different bandwidth allocations.

17. The method of claim 16, wherein said DBA algorithm generates at least three different bandwidth maps for use over a single DBA cycle.

18. The method of claim 11, wherein a number of MAC frames used in a single DBA cycle is a positive integer multiplier of said ONU cycles.

19. A communications node in a passive optical network comprising:
a processor for executing instructions; and
a communications interface which transmits at least one data packet toward an optical line termination (OLT) during each of a plurality of optical network unit (ONU) cycles,
wherein at least one of said ONU cycles has a time duration of a plurality of Media Access Control (MAC) frame periods.

20. The communications node of claim 19, wherein each of said MAC frame periods is a Gigabit Passive Optical Network (GPON) transmission convergence (GTC) frame period of 125 microseconds.

21. The communications node of claim 19, wherein said communications interface receives a first bandwidth allocation message from said OLT during a dynamic bandwidth allocation (DBA) cycle, and said processor and said communications interface generate and optically transmit a first number of said at least one data packets during a first ONU cycle within said DBA cycle, which first number is based upon said first bandwidth allocation message; and
further wherein said communications interface receives a second bandwidth allocation message from said OLT during said dynamic bandwidth allocation (DBA) cycle, and said processor and said communications interface generate and optically transmit a second number of said at least one data packets during a second ONU cycle within said DBA cycle, which second number is based upon said second bandwidth allocation message, wherein said first number is different from said second number.

22. The communications node of claim 19, wherein a number of MAC frames used in a single DBA cycle is a positive integer multiplier of said ONU cycles.

23. A communications node in a passive optical network comprising:
a memory for storing program instructions associated with a dynamic bandwidth allocation (DBA) algorithm;
a processor for executing said program instructions associated with said DBA algorithm which results in generation of a plurality of different bandwidth maps which describe a DBA cycle associated with upstream transmissions; and
a communications interface for transmitting said plurality of different bandwidth maps in downstream frames during said DBA cycle.

24. The communications node of claim 23, wherein said processor generates, and said communications interface transmits, a single bandwidth map for another DBA cycle having a time duration of a single Medium Access Control (MAC) frame period.

25. The communications node of claim 23, wherein said plurality of bandwidth allocation messages are optically transmitted to a plurality of ONUs and inform each of said plurality of ONUs regarding their respective upstream bandwidth allocation.

26. The communications node of claim 23 wherein said communications interface optically transmits a first bandwidth allocation message based upon a first bandwidth map from said plurality of different bandwidth maps;
wherein said communications interface receives a first number of data packets from one of a plurality of ONUs associated with a first ONU cycle within said DBA cycle, which first number is based upon said first bandwidth allocation message;
wherein said communications interface optically transmits a second bandwidth allocation message based upon a second bandwidth map from said plurality of bandwidth maps; and
wherein said communications interface receives a second number of data packets from one of said plurality of ONUs associated with a second ONU cycle within said DBA cycle, which second number is based upon said second bandwidth allocation message, said second number of data packets being different from said first number of data packets.

27. The communications node of claim 23, wherein at least some of said ONU cycles have a time duration of a plurality of Media Access Control (MAC) frame periods.

28. The communications node of claim 27, wherein each of said MAC frame periods is a Gigabit Passive Optical Network (GPON) transmission convergence (GTC) frame period of 125 microseconds.

29. The communications node of claim 27, wherein said DBA algorithm generates, when executed by said processor, different bandwidth allocations for each of said first bandwidth allocation message and said second bandwidth allocation message.

30. The communications node of claim 29, wherein polling information is received by said communications interface from each of said plurality of ONUs for use by said DBA algorithm in generating said different bandwidth allocations.

31. The communications node of claim 30, wherein said DBA algorithm uses constraints of overhead reduction and data packet jitter requirements when generating said different bandwidth allocations.

32. The communications node of claim 31, wherein said DBA algorithm generates at least three different bandwidth maps for use over a single DBA cycle.

33. The communications node of claim 23, wherein a number of MAC frames used in a single DBA cycle is a positive integer multiplier of said ONU cycles.
